(19) United States
(12) Patent Application Publication
(10) Pub. No.: US 2022/0326656 A1
(43) Pub. Date: Oct. 13, 2022

(54) COMPACT OPTICAL ASSEMBLY

(71) Applicant: VividQ Limited, London (GB)

(72) Inventor: Alfred James NEWMAN, London (GB)

(21) Appl. No.: 17/850,748

(22) Filed: Jun. 27, 2022

Related U.S. Application Data
(63) Continuation of application No. PCT/EP2021/051562, filed on Jan. 25, 2021.

(30) Foreign Application Priority Data
Jan. 30, 2020 (GB) 2001291.0

(51) Int. Cl. G03H 1/22; G02B 27/01; G03H 1/32

(52) U.S. Cl. CPC G03H 1/2205; G02B 27/0172; G03H 1/32; G03H 1/2286; G02B 26/10

(57) ABSTRACT

An optical assembly comprises a light source, a light-modulation element for modulating light from the light source, and a terminal optical element for directing modulated light from the optical assembly. Optical elements are provided to guide the light in a first path from the light source to the light-modulation element and to guide the modulated light in a second path from the light-modulation element to the terminal optical element. The first and second paths are of similar shape, for example a c-shape, and are arranged in a nested configuration.

### CROSS-REFERENCE TO RELATED APPLICATIONS

This application is a continuation of International Application No. PCT/EP2021/051562, filed Jan. 25, 2021, which claims priority to GB Application No. GB 2001291.0, filed Jan. 30, 2020, under 35 U.S.C. § 119(a). Each of the above-referenced patent applications is incorporated by reference in its entirety.

### BACKGROUND

### Technical Field

The present invention relates to an optical assembly. More particularly, the optical assembly is for use in a near-eye display such as a holographic augmented-reality (AR) headset or a virtual reality (VR) headset. In such AR and VR headsets, the optical assembly may be used for generating a holographic replay image that is subsequently delivered to a user wearing the headset. Other applications are also considered, such as use in a heads up display (HUD) or a projector.

### Background

Augmented reality (AR) headsets in which a user wears a headset having an appearance similar to glasses are known. In some AR headsets, a 2D image is projected onto a screen element in front of a user's eyes so that the user can see both their surroundings and the image that is projected onto the screen element. The term ‘mixed reality’ is sometimes also used to describe virtual images (images projected onto a screen element) interacting with real objects. For the purposes this application, the term ‘augmented reality’ is understood broadly to include the term ‘mixed-reality’. Virtual reality (VR) headsets are also known, in which a user wears a headset that covers their eyes so that the user sees an image projected onto a screen element but not their surroundings.

AR and VR headsets have a wide range of potential uses from gaming to commercial applications, such as design prototyping.

Several factors are important when designing AR and VR headsets including quality of image reproduction, comfort of the AR and VR headset, and portability. A significant factor in both comfort and portability is the size and weight of the AR and VR headset.

Holographic displays are also known which manipulate light to create a three-dimensional image of an object. The use of spatial light modulators in such displays to control the phase of light to reproduce a 3-dimensional image has also been considered.

The present invention has been made in view of the challenges of designing a headset unit with desirable qualities.

### SUMMARY

According to a first aspect of the present invention, there is provided an optical assembly comprising: a light source; a light-modulation element for modulating light from the light source; a terminal optical element for directing modulated light from the optical assembly; and a plurality of optical elements to guide the light; wherein the plurality of optical elements are positioned to guide the light in a first path from the light source to the light-modulation element and to guide the modulated light in a second path from the light-modulation element to the terminal optical element; and wherein the first and second paths are of similar shape and are arranged in a nested configuration.

This allows a compact design. In particular, the nesting of the first and second paths allows for a more compact arrangement of the optical elements.

The first and second paths may be c-shaped paths arranged in a nested configuration. The use of c-shaped paths allows for easy nesting of the optical paths.

The light source, the light-modulation element, and the terminal optical element may all be positioned in one half of the optical assembly. The light source, the light-modulation element and the terminal optical element may be located on the periphery of the optical assembly. In some examples, a periphery is an exterior surface. This can make wiring to electrical components within the optical assembly easier. In particular, a power source may be provided on the same side of the optical assembly as the light source allowing compact wiring to elements of the optical assembly requiring power.

In some embodiments, the light source, the light-modulation element, and terminal optical element are provided in a substantially linear arrangement such that the first path and second path are provided substantially in a same plane. In addition to making wiring to electrical components easier, this configuration allows a compact optical assembly because the paths are provided in the same or close planes.

The plurality of optical elements within the optical assembly may include a collimator configured to narrow a beam of light from the light source. The narrowing of the beam of light caused by the collimator allows for a more compact optical assembly.

The plurality of optical elements within the optical assembly may comprise a polarising beam splitter located in front of the light-modulation element such that light arriving at the light-modulation element has been reflected by the polarising beam splitter in the first path and modulated light from the light-modulation element passes through the polarising beam splitter in the second path. In such embodiments, the polarising beam splitter controls the transition between the two paths. An advantage is that, by using a polarising beam splitter, the path in and out of the light-modulation element can be used, providing more efficient use of space.

Alternatively, the polarising beam splitter may be in arranged to pass light on the first path. Accordingly, the plurality of optical elements of the optical assembly may comprise a polarising beam splitter located in front of the light-modulation element such that light arriving at the light-modulation element has passed through the polarising beam splitter in the first path and modulated light from the light-modulation element is reflected by the polarising beam splitter in the second path.

A polariser may be provided between the polarising beam splitter and the light-modulation element.

The terminal optical element may take many different forms. In some embodiments the terminal optical element comprises a reflector. The reflector may be a steerable field of view scanning mirror. In further embodiments, the terminal optical element is a laser speckle reducer. Embodiments in which the terminal element requires power may benefit from being either positioned in one half of the optical assembly and/or provided in a substantially linear arrangement as described above, in order to keep wiring compact.

The plurality of optical elements may include a Plossl optical component located on the second path adjacent to the terminal optical element, wherein the Plossl optical component comprises a pair of symmetric optical elements and is configured to generate a reduced image to be output from the optical assembly. Plossl optical components tend to provide good image quality with relatively few optical elements. Additionally, a Plossl optical component has a short focal distance which helps to keep the optical assembly compact.

The optical assembly may comprise a monitor sensor to detect an intensity of light from the light source and to provide feedback to control power to the light source so that an intensity of the light can be regulated.

According to another aspect of the invention, there is provided a holographic display comprising an optical assembly as discussed above, with or without the optional features also described. Such a display may have a compact form. The light-modulation element may be configured to modulate the phase of an incoming light beam in order to generate a replay image. The display may comprise a combiner to combine an image from the optical assembly with light from another light source, which enables augmented reality applications, for example.

In some examples, the display is a near-eye display. The term “near-eye display” is used in the art to encompass applications where a display is positioned close to an eye in use, such as in VR and AR applications. For example, a near-eye display may be within 10 mm, within 20 mm, within 30 mm, within 40 mm, within 50 mm, within 100 mm or within 200 mm of the eye. In one example, the holographic display is a binocular holographic near-eye display, comprising a first optical assembly and a second optical assembly. Each of the optical assemblies may be positioned so that they generate a respective replay image in field of vies of a respective one of the eyes of a user. The near-eye display may be a self-contained headset. A self-contained headset is one where the components of the optical engine are supported by a user's head rather than an external structure and is enabled by the compact construction of the optical system. A self-contained headset can be provided with a cable connection for power and/or data or have no cable connections, for example using wireless communication protocols and comprising a power source within the headset.

According to another aspect of the invention there is provided a heads up display comprising an optical assembly as discussed above. According to yet another aspect of the invention there is provided a projector comprising an optical assembly as discussed above.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram showing components of a holographic augmented-reality headset;

FIG. 2 is a diagram showing components within an optical engine shown in FIG. 1;

FIG. 3 is a schematic diagram showing some components of the optical engine shown in FIG. 2;

FIG. 4 is a schematic diagram showing a second embodiment of the present invention; and

FIG. 5 shows a holographic augmented-reality headset.

### DETAILED DESCRIPTION

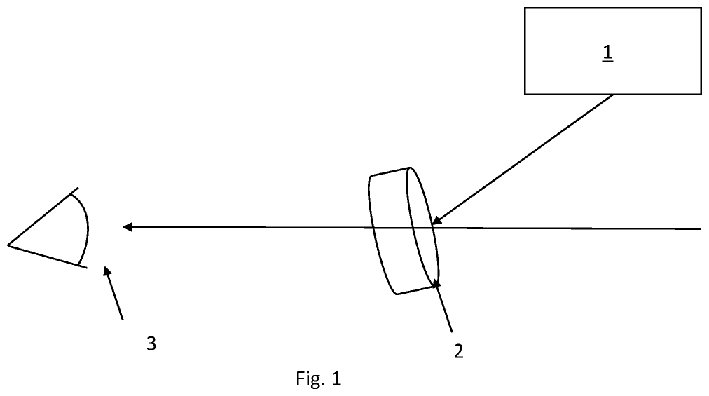

FIG. 1 shows, in general terms, components of a holographic augmented-reality headset comprising an optical assembly in the form of an optical engine 1 and an optical combiner 2 for combining light from the optical engine 1 with light from a user's surroundings and displaying it to a user. By combining the light from the surroundings with the image generated by the optical engine 1 an augmented reality effect can be created for a user. The optical combiner 2 generally comprises one or more optical elements to guide light from the optical engine 1 and a display element that combines the holographic image with light from a user's surroundings to deliver the combined light to the user for viewing. The optical combiner 2 guides light from the optical engine 1 to a user's eye 3.

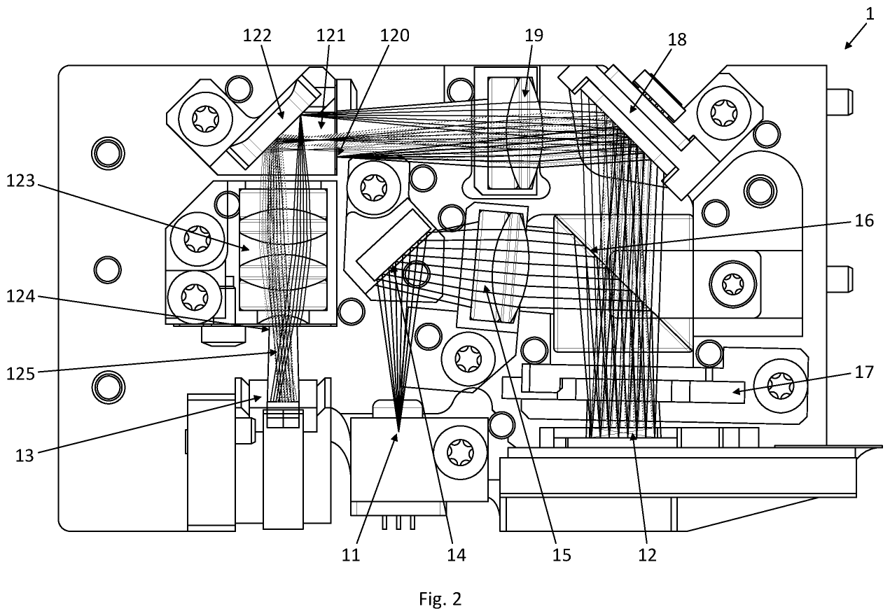

FIG. 2 shows greater detail of the optical engine 1 in a plan view. The optical engine 1 includes a light source in the form of an RGB laser diode 11 (hereinafter ‘laser diode’) which is configured to illuminate a light modulation element in the form of a spatial light modulator 12. The laser diode 11 is a Sumitomo Electric® SLM-RGB-T20-F-2 laser diode, but other laser diodes may be used. The laser diode 11 outputs diverging laser light. The light is emitted with a vertical polarisation (vertical direction being out of the page when viewing FIG. 2) and with greater divergence in the horizontal plane (in the plane of the page). The laser diode 11 is referred to as an RGB laser diode because it rapidly switches between emitting different colours of laser light, periodically emitting red, green, and blue light. By modulating the laser light in different times when the different colours are emitted the appearance of a colour holographic image may be created for a user.

The spatial light modulator 12 is a Compound Photonics® DP1080p26 micro-display and is configured to adjust the phase of light incident upon it. By controlling the phase of light, it is possible to use interference to create a holographic replay image (hereinafter ‘replay image’). The spatial light modulator 12 comprises an array of pixels. Each pixel includes a variable liquid crystal retarder in front of a mirrored back-plane that can be controlled to adjust the phase of the reflected light. The present invention is not tied to a particular spatial light modulator technology or display, and it is expected that this technology will change over time, for example increasing in resolution and refresh rate. The replay image is output from the optical engine 1 at a terminal optical element in the form of an output fold mirror 13, more specifically a metallic plano mirror. Referring to FIG. 1, the light from the output fold mirror 13 is sent to the optical elements of the optical combiner 2 for delivery to the user.

Optical elements are provided to guide the light from the laser diode 11 to the spatial light modulator 12. A reflector in the form of a first fold mirror 14 is provided opposite the laser diode 11 which serves to reflect light from the laser diode 11. As with the output fold mirror 13, the first fold mirror 14 is a metallic plano mirror.

The light from the first fold mirror 14 is directed towards a collimator in the form of a laser collimating lens 15, which is a component that narrows a diverging beam of light. In the first embodiment, the laser collimating lens 15 narrows the light from the first fold mirror 14 such that upon leaving the laser collimating lens 15 the light beam is converging slightly. In the present embodiment, the laser collimating lens 15 is a component AC080-016-A from Thorlabs®, but another collimating lens may be used.

The path between the first fold mirror 14 and the laser collimating lens 15 is enclosed by a baffle, which is not shown in FIG. 2. The baffle may be 3D printed to conform to the shape of the components and the light path.

After passing through the laser collimating lens 15, the collimated light is incident upon a polarising beam splitter 16. The polarising beam splitter 16 is configured to reflect light with a vertical polarisation (out of the paper as shown) and pass light with a horizontal polarisation (in the plane of the paper as shown). The polarising beam splitter 16 is a component PBS101 from Thorlabs®, but another polarising beam splitter could be used.

As mentioned previously, the light is emitted from the laser diode 11 with a vertical polarisation. The polarising beam splitter 16 is configured so that nearly all the light is reflected from the polarising beam splitter 16 towards to the spatial light modulator 12.

It can be seen from FIG. 2, that the light from the laser diode 11 takes a first c-shaped path to the spatial light modulator 12. In particular, the three sides of the c are formed by light passing i) from the laser diode 11 to the first fold mirror 14, ii) from the first fold mirror 14 to the polarising beam splitter 16, and iii) from the polarising beam splitter 16 to the spatial light modulator 12.

Looking more carefully at FIG. 2, the laser collimating lens 15 is provided at a slight angle to the optical axis of the polarising beam splitter 16. This slight angle is the width of the replay field divided by two and is calculated as follows:

$$θ = \frac{λmin}{2 δ}$$

where λₘᵢₙ is a shortest wavelength in the light beam, δ is the pixel pitch of the spatial light modulator, and θ is the angle at which the axis of the laser collimating lens 15 is off-axis from the optical axis of the polarising beam splitter 16. A typical value for θ might be in the region of 3 to 6 degrees. In the first embodiment, the shortest wavelength is 450 nm, the pixel pitch is 3 μm, and the angle θ is 4.3 degrees.

The reason for this off-axis alignment of the laser collimating lens 15 is to cause the centre of the collimated light to be illuminated onto the spatial light modulator 12 off-axis. This means that the centre of the light hits the spatial light modulator 12 in the centre of the spatial light modulator 12 but at an angle to the normal axis of the spatial light modulator 12. The spatial light modulator 12 is illuminated off-axis due to the tilt of the laser collimating lens 15, but is should be noted that all optics subsequent to the spatial light modulator 12 are located on-axis. This is because aberrations caused by the light path up to the spatial light modulator 12 can be fully corrected in software, by adding a fixed phase mask to the image modulated at the spatial light modulator 12, whereas aberrations after the spatial light modulator 12 are difficult to correct.

A polariser 17 is provided between the polarising beam splitter 16 and the spatial light modulator 12. The polariser 17 is a plane polariser and is arranged with a plane of polarisation at 45 degrees between the horizontal and vertical planes of polarisation. Consequently, when light passes through the polariser 17 from the polarising beam splitter 16 to the spatial light modulator 12, around 50% of the vertically polarised light is transmitted to the spatial light modulator 12. Light is reflected from the spatial light modulator 12 without a change in polarisation direction, such that substantially all the light from the spatial light modulator 12 arrives at the polarising beam splitter 16 with a polarisation direction at 45 degrees to the vertical and horizontal polarisations. Accordingly, little light is lost at the polariser 17 as the light returns from the spatial light modulator 12. The polarising beam splitter 16 passes around half of the reflected light from the spatial light modulator 12. The other half is reflected back towards the laser collimating lens 15, the first fold mirror 14 and the laser diode where it is absorbed with minimal interference to emitted light.

The above configuration is optimal when using the Compound Photonics® DP1080p26 spatial light modulator mentioned above, because the spatial light modulator works well with incident light that has a 45-degree polarisation. However, other examples of spatial light modulator may work optimally with a different polarisation of light. In such cases, a birefringent element can be added between the polariser 17 and the spatial light modulator 12 to rotate the polarisation of the light to a preferred angle. Other configurations are also possible, including using a non-polarising beam splitter.

The polariser 17 is tilted at a slight angle to the optical axis of the polarising beam splitter 16. In the present embodiment the polariser 17 is tilted by 1 degree to the optical axis. However, using the manufacturing tolerance of installation of the polariser 17 may also provide a satisfactory result. The reason for the tilt is to ensure that any direct reflections from the surfaces of the polariser 17 are sent to the opposite side of the zero-order light from the light of the replay image.

At the spatial light modulator 12 the incident light is reflected from the micro-display which controls its phase to create a replay image. However, due to imperfections in the spatial light modulator 12 and non-addressable areas between pixels, diffraction causes a zero-order light beam to form. The zero-order beam may be quite bright and is undesirable to display to a user. As the incident light beam on the spatial light modulator 12 is off-axis, the zero-order beam also forms off-axis.

The light from the spatial light modulator 12 which is passed by the polarising beam splitter 16 reaches a reflector in the form of a second fold mirror 18 located opposite the spatial light modulator 12 on an opposite side of the optical engine 1. As with the first fold mirror, the second fold mirror 18 is a metallic plano mirror. The light is reflected by the second fold mirror 18 towards a focusing system in the form of an objective lens 19. The objective lens 19 serves to focus the modulated light into different focal planes to form a real intermediate image 121. The objective lens is a component AC080-020-A from Thorlabs®, but other optical components may be used.

A light remover in the form of a field-stop aperture 120 is provided after the objective lens 19 to remove the zero-order light as will now be explained in more detail. The zero-order light from the spatial light modulator 12 focused by the objective lens 19 has passed through the polarising beam splitter 16 and was reflected by the second fold mirror 18 to arrive at the field-stop aperture 120. Further, as explained earlier in connection with the laser collimating lens 15, the light from the laser collimating lens 15 is slightly converging when it hits the spatial light modulator 12 off-axis due to the off-axis arrangement of the laser collimating lens 15. Consequently, the zero-order light is off-axis and slightly converging and is focused by the objective lens 19 so that it can be removed by the field-stop aperture 120. The zero-order light is focused on or close to a solid portion of the field-stop aperture 120. The modulated light from the spatial light modulator 12 is focused by the objective lens 19 and passes through the aperture of the field stop aperture 120 to form a replay image after the field-stop aperture 120. The infinity plane of focus (parallel light) of the replay image will be focused by the objective lens 19 after the field-stop aperture 120 because, as just noted, the zero-order light was already slightly converging at the spatial light modulator 12 and so will focus earlier.

Any direct reflected light from the polariser 17, mentioned above, will also be cut out by the field-stop aperture 120 as it was located to the opposite side of the zero-order light compared to the light of the replay image.

The field-stop aperture 120 may, optionally, have a light sensor positioned on it or nearby to positively account for the zero-order light hitting the field-stop aperture 120. In such embodiments, the detection of light from the sensor may be used to logically control the power to the laser diode 11. In particular, if power is supplied to the laser diode 11 (i.e. the laser diode is outputting a laser beam) then if no light is detected by the sensor, a control unit (not shown) may cut power to the laser diode 11 because the zero-order light cannot be accounted for. This prevents the zero-order light being inadvertently passed on to the user due to misconfiguration of the optical engine 1.

The spatial light modulator 12 may be tilt-ably mounted to allow control of positioning of the zero-order light on the field-stop aperture 120. Control of the angle of tilt of the spatial light modulator 12 may be by a tilt-able mounting of a type known in the art. Alternatively, the spatial light modulator 12 may be adjusted (for example, shimmed) during manufacture to adjust its orientation.

The real intermediate image 121 is formed in various focal planes beyond the field-stop aperture 120 and is a 3-D holographic replay image. By removing the zero-order light in a plane before the planes of focus of the replay image, a harsh edge to the field of view, caused by the field-stop aperture 120 can be avoided. Further, because the zero-order light focusses before the region where the intermediate image is formed, the zero-order light is diverging in the intermediate image and the user cannot focus on it. This is also an advantageous safety feature.

The light from the objective lens 19, from which the zero-order light has now been removed is reflected by a reflector in the form of a third fold mirror 122, again a metallic plano mirror, before entering a Plossl optical component in the form of a Plossl optical element 123. The Plossl optical element 123 is of a known type and produces a de-magnified image ready to be output by the output fold mirror 13. The Plossl optical element 123 is sometimes referred to as a ‘Plossl eyepiece’ and comprises two symmetric optical elements. In the present embodiment, the two symmetric optical elements are components AC064-013-A from Thorlabs®, but other optical components could be used. Advantages of this optical element are that it comprises relatively few optical elements, has a good field of view and provides good image quality. The focal distance of a Plossl eyepiece is typically quite short, which helps with keeping the optical engine 1 compact.

A second aperture 124 is provided after the Plossl optical element 123. At this stage, it is appropriate to discuss an additional function of the second fold mirror 18. The second fold mirror 18 is provided in a recess, which effectively provides an aperture. The second aperture 124 and recess of the second fold mirror 18 both remove stray off-axis light and improve the appearance of the replay image for the user.

A reduced (de-magnified) image of the spatial light modulator 12 is formed by the Plossl optical element in a region 125 after the Plossl optical element 123 and before the light is reflected by the output fold mirror 13 towards the optical combiner 2. In the first embodiment the replay image formed in the region 125 has a size approximately one third of the size of the replay image generated by the spatial light modulator 12.

The optical combiner 2 can be one of several known combiners for an augmented reality headset. For example, the combiner could use a semi-transparent mirror or beam splitter to combine the replay image from the optical engine 1 with light entering the headset from outside. The combiner 2 may be a ‘birdbath’ combiner of a type known in the art including planar and spherical elements.

It can be seen from FIG. 2, that the light takes a second c-shaped path from the spatial light modulator 12 to the output fold mirror 13. In particular, the three sides of the c are formed by light passing i) from the spatial light modulator 12 to the second fold mirror 18, ii) from the second fold mirror 18 to the third fold mirror 122, and iii) passing from the third fold mirror 122 to the output fold mirror 13.

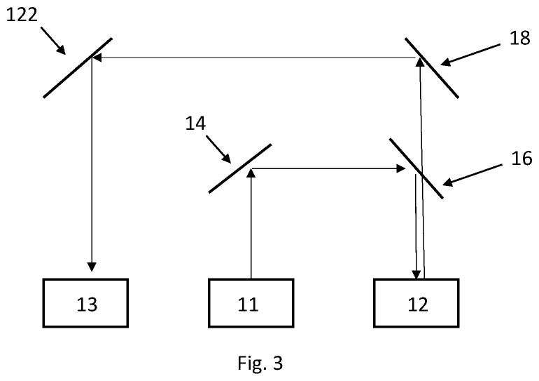

FIG. 3 is a schematic diagram showing certain components from FIG. 2 in order to allow the paths taken by the laser light to be more easily appreciated. FIG. 3 shows the laser diode 11, the first fold mirror 14, the polarising beam splitter 16, the spatial light modulator 12, the second fold mirror 18, the third fold mirror 122 and the output fold mirror 13. The first c-shaped path can be seen between laser diode 11 and spatial light modulator 12 as explained previously and the second c-shaped path can be seen between the spatial light modulator 12 and the output fold mirror 13. The laser diode 11, spatial light modulator 12 and output fold mirror 13 are all provided in one half of the optical engine 1. More particularly, they are arranged in a substantially linear arrangement. Additionally, the first c-shaped path is nested within the second c-shaped path. This has several advantages. Firstly, the nesting of the first and second c-shaped paths allows for a compact arrangement of the optical elements. This reduces the size of the headset which improves the user experience. Secondly, because the laser diode 11 and the spatial light modulator 12, the components that require a power supply, are provided close to each other, the wiring for the device can be made compact and efficient.

The overall dimensions of the optical engine of FIGS. 2 and 3 can be as small as 25×30×10 mm allowing easier integration into components such as headsets, where compact size is beneficial.

In the first embodiment the terminal optical element is an output fold mirror 13. However, in other embodiments, the output fold mirror 13 may be replaced by a steerable field-of-view scanning mirror to allow adjustment of the field of view or a micro-scale vibrator to smooth out speckle noise caused by use of the laser diode 11. Each of these components require a power supply and are, again, advantageously located close to each other on one side of the optical engine 1 in order to allow compact and efficient wiring.

The optical engine 1 is capable of good optical performance and may, in some cases, produce a near diffraction-limited image to be re-imaged for the user via the optical combiner 2.

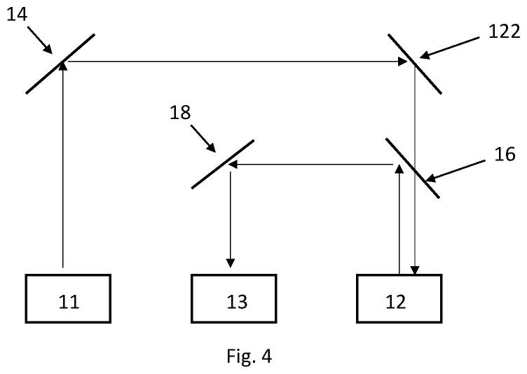

FIG. 4 illustrates a second embodiment of the invention in which first c-shaped path between the laser diode 11 and the spatial light modulator 12 and the second c-shaped path between the spatial light modulator 12 and the output fold mirror 13 or another output optical element are reversed. In this embodiment the light from the laser diode 11 first travels around the outside of the optical engine 1 before traveling in the second c-shaped path nested within the first c-shaped path.

In the second embodiment, the order of the optical components is substantially unchanged. However, the position of the laser diode 11 is swapped with the position of the output fold mirror 13. As before, the laser collimating lens 15 is provided after the first fold mirror 14 and before the polarising beam splitter 16. The laser collimating lens 15 may be provided either before or after the fold mirror 122. The location of the polariser 17 is unchanged and remains between the polarising beam splitter 16 and the spatial light modulator 12. The objective lens 19 is provided in the path between the polarising beam splitter 16 and the fold mirror 18. The position of the fold mirrors 18 and 122 is swapped to allow the recess in which the fold mirror 18 is located to cut-out off-axis light after the light modulation element 12. The field-stop aperture 120 is located after the objective lens 19 and before the fold mirror 18. The Plossl optical element 123 is provided after the fold mirror 18 and before the output fold mirror 13. The second aperture 124 follows the Plossl optical element 123 as before.

The skilled person will appreciate that the polarisation of the light output by the laser diode 11 and/or the polarisation of the polarising beam splitter can be adjusted so that the polarising beam splitter transmits the light on the first c-shaped path and reflects the light on the second c-shaped path.

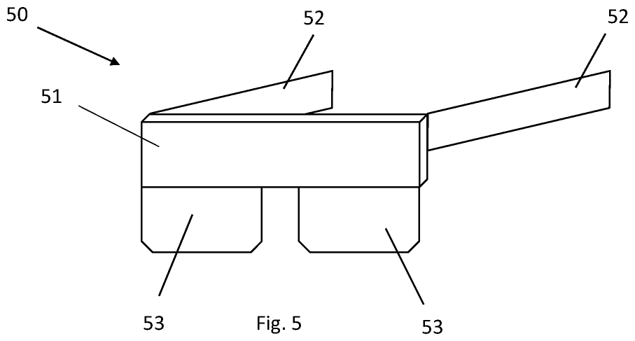

FIG. 5 shows a holographic augmented-reality headset 50 according to a further embodiment of the invention. The holographic augmented-reality headset 50 comprises a main housing 51, a pair of arms 52 and a pair of optical combiners 53. The main housing 51 contains a pair of optical engines (not shown), of a type just described in connection with the first or second embodiments. A first of the pair of optical engines generates a holographic image for display in the right eye of a user and a second of the optical engines generates a holographic image for display in the left eye of a user. The optical combiners 53 are transparent screens and are configured to deliver the holographic replay images to the user. In use, the user can look through the optical combiners 53 to view the holographic replay images generated by the optical engines.

The above embodiments are to be understood as illustrative examples of the invention. Further embodiments of the invention are envisaged. For example, although not shown in the figures, the optical engine 1 may further include a monitor photodiode to measure light intensity (brightness) from the laser diode 11. The monitor photodiode may be provided close to the laser diode 11 or further down the optical path. The laser photodiode is provided to measure light intensity. The measured level of light is then used to control power to the laser diode 11 thereby allowing closed-loop control of laser power to ensure uniform laser brightness.

The use of an optical engine in connection with a headset has been described above. However, in further embodiments, the optical engine is used in other applications than headsets. For example, a projector may include an optical engine as described in any of the preceding embodiments. The projector may be a pico projector or a LCoS projector. LCoS stands for Liquid Crystal on Silicon and is a known technology that is not described in detail here. In other embodiments, the optical engine could be included in a heads up display (HUD). For example, the HUD may be suitable for use in automotive applications.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An optical assembly comprising:
a light source;
a light-modulation element for modulating light from the light source;
a terminal optical element for directing modulated light from the optical assembly; and
a plurality of optical elements to guide the light;
wherein the plurality of optical elements is positioned to guide the light in a first path from the light source to the light-modulation element and to guide the modulated light in a second path from the light-modulation element to the terminal optical element; and
wherein the first and second paths are of similar shape and are arranged in a nested configuration.

2. The optical assembly according to claim 1, wherein the first and second paths are c-shaped paths arranged in a nested configuration.

3. The optical assembly according to claim 1, wherein the light source, the light-modulation element, and the terminal optical element are located on the periphery of the optical assembly.

4. The optical assembly according to claim 3, wherein the light source, the light-modulation element, and terminal optical element are provided in a substantially linear arrangement such that the first path and second path are provided substantially in a same plane.

5. The optical assembly according to claim 1, wherein the plurality of optical elements includes a collimator configured to narrow a beam of light from the light source.

6. The optical assembly according to claim 1, wherein the plurality of optical elements comprise a polarising beam splitter located in front of the light-modulation element such that light arriving at the light-modulation element has been reflected by the polarising beam splitter in the first path and modulated light from the light-modulation element passes through the polarising beam splitter in the second path.

7. The optical assembly according to claim 6, wherein a polariser is provided between the polarising beam splitter and the light-modulation element.

8. The optical assembly according to claim 1, wherein the terminal optical element comprises a reflector.

9. The optical assembly according to claim 1, wherein the terminal optical element is a steerable field of view scanning mirror.

10. The optical assembly according to claim 1, wherein the terminal optical element is a laser speckle reducer.

11. The optical assembly according to claim 1, wherein the plurality of optical elements includes a Plossl optical component located on the second path adjacent to the terminal optical element, wherein the Plossl optical component comprises a pair of symmetric optical elements and is configured to generate a reduced image to be output from the optical assembly.

12. A holographic display comprising an optical assembly, wherein the optical assembly comprises:
a light source;
a light-modulation element for modulating light from the light source;
a terminal optical element for directing modulated light from the optical assembly; and
a plurality of optical elements to guide the light;
wherein the plurality of optical elements is positioned to guide the light in a first path from the light source to the light-modulation element and to guide the modulated light in a second path from the light-modulation element to the terminal optical element; and
wherein the first and second paths are of similar shape and are arranged in a nested configuration.

13. The holographic display according to claim 12, wherein the light-modulation element is configured to modulate the phase of an incoming light beam in order to generate a replay image.

14. The holographic display according to claim 12, comprising a combiner to combine an image from the optical assembly with light from another light source.

15. The holographic display according to claim 12, wherein the holographic display is a near-eye display.

16. The holographic display according to claim 15, wherein the holographic display is a binocular near-eye display comprising a first optical assembly and a second optical assembly.

17. The holographic display according to claim 15, in the form of a self-contained headset.

18. A holographic display comprising:
a light source;
a light-modulation element for modulating light from the light source;
a terminal optical element for directing modulated light from the optical assembly; and
a plurality of optical elements to guide the light; and
wherein the plurality of optical elements is positioned to guide the light in a first substantially c-shaped path from the light source to the light-modulation element and to guide the modulated light in a second substantially c-shaped path from the light-modulation element to the terminal optical element.

19. The holographic display according to claim 18, wherein the first substantially c-shaped path and the second substantially c-shaped path are arranged in a nested configuration.

20. The holographic display according to claim 18, wherein the light source, the light-modulation element, and the terminal optical element are located on the periphery of the optical assembly and are provided in a substantially linear arrangement such that the first path and second path are provided substantially in a same plane
